(19) United States
(12) Patent Application Publication
(10) Pub. No.: US 2025/0300823 A1
(43) Pub. Date: Sep. 25, 2025

(54) SECURE KEY GENERATION USING DEVICE IDENTIFIERS

(71) Applicant: Micron Technology, Inc., Boise, ID (US)

(72) Inventors: Lance W. Dover, Fair Oaks, CA (US); James Ruane, San Jose, CA (US)

(21) Appl. No.: 19/085,401

(22) Filed: Mar. 20, 2025

Related U.S. Application Data
(60) Provisional application No. 63/568,946, filed on Mar. 22, 2024.

(51) Int. Cl. H04L 9/08; H04L 9/32

(52) U.S. Cl. CPC H04L 9/0866; H04L 9/0825; H04L 9/0869; H04L 9/3263

(57) ABSTRACT

Methods, systems, and devices for secure key generation using device identifiers are described. A memory system may use a hardware component, a software component, or both as an input to generate a device identifier. The memory system may apply one or more functions to the device identifier, such as a key derivation function, to generate a wrapping key. Additionally, the memory system may generate an asymmetric key pair using one or more second functions. In some cases, the memory system may use a randomly generated number as an input to the one or more second functions. The memory system may encrypt the asymmetric key pair using the wrapping key. In some examples, the memory system may generate a certificate using the encrypted asymmetric key pair, and may transmit the certificate to a host system to attest the identity of the memory system to the host system.

### CROSS REFERENCE

The present Application for Patent claims priority to U.S. Patent Application No. 63/568,946 by Dover et al., entitled “SECURE KEY GENERATION USING DEVICE IDENTIFIERS,” filed Mar. 22, 2024, which is assigned to the assignee hereof, and which is expressly incorporated by reference in its entirety herein.

### TECHNICAL FIELD

The following relates to one or more systems for memory, including secure key generation using device identifiers.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports secure key generation using device identifiers in accordance with examples as disclosed herein.

FIG. 2 shows an example of a process that supports secure key generation using device identifiers in accordance with examples as disclosed herein.

FIG. 3 shows a block diagram of a memory system that supports secure key generation using device identifiers in accordance with examples as disclosed herein.

FIG. 4 shows a flowchart illustrating a method or methods that supports secure key generation using device identifiers in accordance with examples as disclosed herein.

### DETAILED DESCRIPTION

Secure communication between a memory system and a host system may include generating and managing cryptographic keys (e.g., one or more cryptographic keys), such as asymmetric key pairs (e.g., key pairs including a public key and a private key), keys used to encrypt and decrypt certificates associated with the asymmetric key pairs, and so on. In some cases, security protocols may utilize various rules for generating and using keys. For example, a security protocol may specify that a key be used for a single purpose (e.g., for generating another key, for encrypting or decrypting a particular file, such as a certificate), which may introduce complexity in the algorithms used to generate keys and securely communicate certificates. This complexity may lead to an increase in computational resource consumption and may lead to a decrease in efficiency, as a memory system may expend additional resources to generate and manage cryptographic keys.

As described herein, a memory system may use both a hardware component and a software component as an input to generate a device identifier, such as a compound device identifier (CDI). The memory system may apply one or more functions to the device identifier, such as a key derivation function (KDF), to generate a wrapping key that may be used to encrypt or decrypt (or both) one or more additional keys. Additionally, the memory system may generate an asymmetric key pair (e.g., a public key and a private key) using one or more second functions. In some cases, the memory system may use a randomly generated number (e.g., generated using a secure random number generator) as an input to the one or more second functions. The memory system may encrypt the asymmetric key pair using the wrapping key. In some examples, the memory system may generate a certificate using the encrypted asymmetric key pair, and may transmit the certificate to a host system to attest the identity of the memory system to the host system (e.g., to attest that both the software component and the hardware component are legitimate). Such techniques may allow the memory system to efficiently incorporate the device identifier in various security protocols, which may improve the security of the communication between the memory system and the host system and decrease complexity associated with generating and securely communicating certificates, and accordingly decrease computational resource consumption, among other benefits.

In addition to applicability in memory systems described herein, techniques for secure key generation using device identifiers may be generally implemented to improve security and/or authentication features of various electronic devices and systems. As the use of electronic devices for handling private, user, or other sensitive information has become even more widespread, electronic devices and systems have become the target of increasingly frequent and sophisticated attacks. Further, unauthorized access or modification of data in security-critical devices such as vehicles, healthcare devices, and others may be especially concerning. Implementing the techniques described herein may improve the security of electronic devices and systems by incorporating a device identifier in various security protocols, and may prevent or mitigate unauthorized access to data or other information, incur lower latency costs, and use less power relative to other solutions, among other benefits.

Features of the disclosure are illustrated and described in the context of systems, devices, and circuits. Features of the disclosure are further illustrated and described in the context of a process and flowcharts.

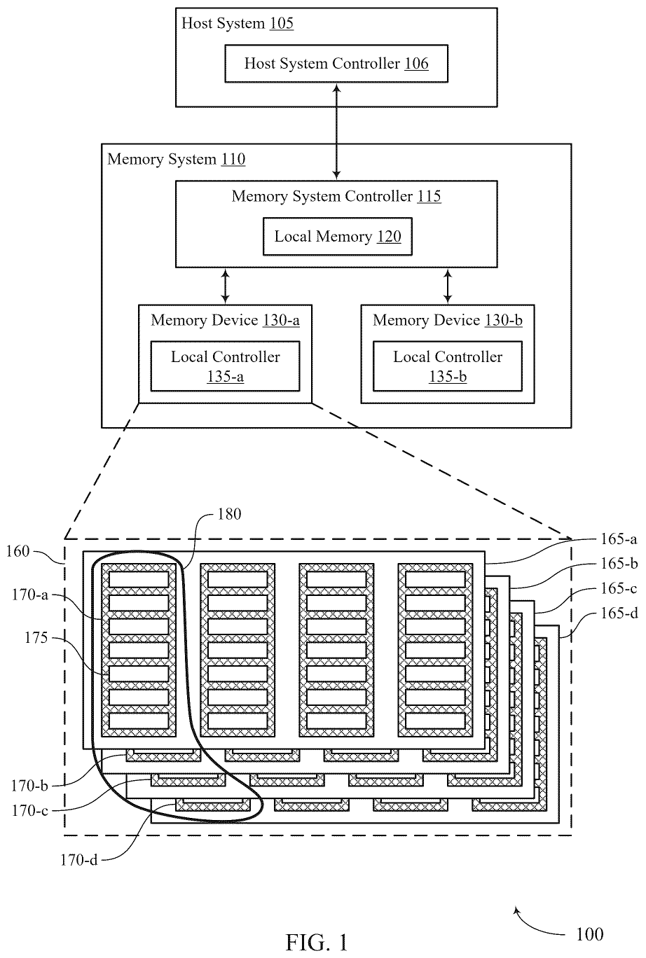

FIG. 1 shows an example of a system 100 that supports secure key generation using device identifiers in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCle interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically crasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The system 100 may include any quantity of non-transitory computer readable media that supports secure key generation using device identifiers. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

A memory system 110 may use both a hardware component and a software component as an input to generate a device identifier, such as a CDI. The memory system 110 may apply one or more functions to the device identifier, such as a KDF, to generate a wrapping key. Additionally, the memory system 110 may generate an asymmetric key pair (e.g., a public key and a private key) using one or more second functions. In some cases, the memory system 110 may use a randomly generated number (e.g., generated using a secure random number generator) as an input to the one or more second functions. The memory system 110 may encrypt the asymmetric key pair using the wrapping key. In some examples, the memory system 110 may generate a certificate using the encrypted asymmetric key pair, and may transmit the certificate to a host system 105 to attest the identity of the memory system 110 to the host system (e.g., to attest that both the software component and the hardware component are legitimate). Such techniques may allow the memory system 110 to efficiently incorporate the device identifier in various security protocols, which may improve the security of the communication between the memory system 110 and the host system 105 and decrease complexity associated with generating and securely communicating certificates, and accordingly decrease computational resource consumption, among other benefits.

The system 100 may include any quantity of non-transitory computer readable medias that support secure key generation using device identifiers. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

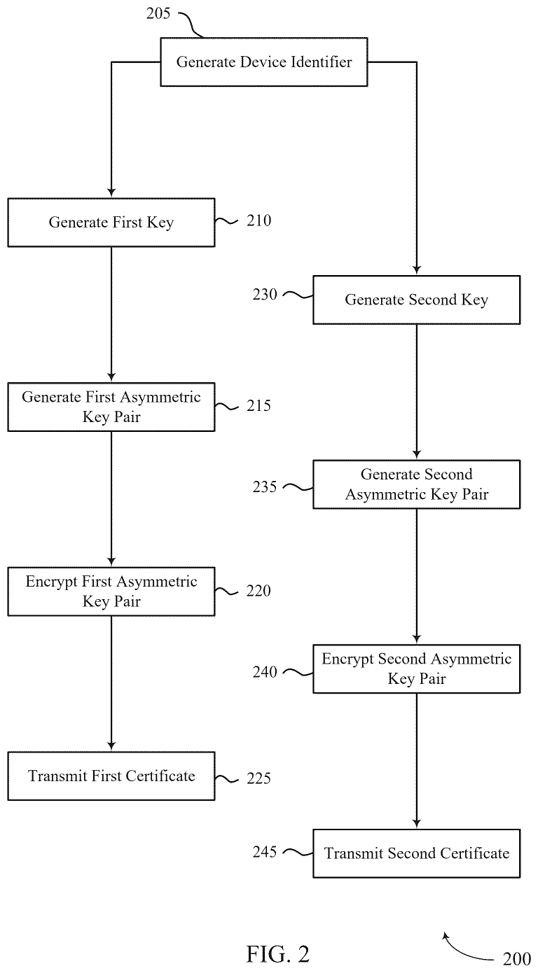

FIG. 2 shows an example of a process 200 that supports secure key generation using device identifiers in accordance with examples as disclosed herein. In some examples, a memory system, which may be an example of the memory system 110 as described with reference to FIG. 1, may implement aspects of the process 200 using one or more memory system controllers (e.g., a memory system controller 115). In the following description of process 200, the operations may be performed in a different order than the order shown. For example, specific operations may also be left out of process 200, or other operations may be added to process 200.

Aspects of the process 200 may be implemented by processing circuitry, such as one or more controllers, among other components. Additionally, or alternatively, aspects of the process 200 may be implemented as instructions stored in one or more memories (e.g., firmware stored in one or more memories, such as a memory device 130 or local memory 120 (or both), coupled with the memory system). For example, the instructions, when executed by one or more controllers (e.g., the memory system controller 115), may cause the one or more controllers (or a device or a system) to perform the operations of the process 200.

The process 200 may illustrate a method to securely generate one or more keys in accordance with various security protocols, such as by complying with information processing standards while implementing hardware and software based cryptographic techniques, including device identifier composition engine (DICE) techniques. The memory system may use both a hardware component and a software component as an input to generate a device identifier, such as a CDI.

The memory system may apply one or more functions to the device identifier to generate a wrapping key. As described herein, a wrapping key may refer to a key used to encrypt or decrypt (or both) keying material. For example, a wrapping key may be used as part of a symmetric encryption algorithm to encrypt one or more additional keys, and may be used to decrypt the encrypted additional keys. Additionally, the memory system may generate an asymmetric key pair (e.g., a public key and a private key) using one or more second functions. In some cases, the memory system may use a randomly generated number (e.g., generated using a secure random number generator) as an input to the one or more second functions. The memory system may encrypt the asymmetric key pair using the wrapping key. In some examples, the memory system may generate a certificate using the encrypted asymmetric key pair, and may transmit the certificate to a host system to attest the identity of the memory system to the host system (e.g., to attest that both the software component and the hardware component are legitimate).

At 205, the memory system may generate a device identifier. In some examples, the device identifier may be generated using a hardware component of the memory system, a software component of the memory system, or both. For example, the device identifier may include a cryptographic representation of a software image of the memory system, such as a hash or digest of the software image. The software image may include initialization instructions for a computing system including the memory system (e.g., boot code), an operating system for a computing system including the memory system, or both. In some cases, the software component may be based on firmware associated with the memory system (e.g., firmware used to operate the memory system). In such cases, the software image may include the firmware.

Additionally, the device identifier may include a cryptographic representation of a hardware layer of the memory system, such as a physically unclonable function (PUF) of the memory system. The cryptographic representation of the hardware layer may include various components or circuit elements that have an intrinsic physical characteristic that are unique to the memory system, which may be leveraged to establish an intrinsic uniqueness of the memory system. For example, the cryptographic representation of a hardware layer may include a set of one or more transistors, resistors, capacitors, memory cells (e.g., SRAM cells, which may, in some cases, be included in local memory 120 of the memory system 110 described with reference to FIG. 1), or other circuit elements or combination thereof which, if accessed, support the generation of a digital signature that is unique to the memory system.

At 210, the memory system may generate a first wrapping key (e.g., a device identifier wrapping key) using the device identifier. Because the device identifier may be an example of keying material in accordance with various security protocols, the memory system may use the device identifier to generate a cryptographic key that complies with the security protocols. In some cases, the memory system may generate the first wrapping key by applying a function, such as a KDF, to the device identifier. For example, the function may be an example of a key-based KDF (KBKDF) or other key generation function compliant with various security protocols and standards. The memory system may use the device identifier as an input to the function. Additionally, the memory system may use one or more additional inputs, such as a fixed input string, as inputs to the function. Inputting the device identifier and the one or more additional inputs to the function may output the first wrapping key.

At 215, the memory system may generate a first asymmetric key pair (e.g., a device identifier public key and a device identifier private key). In some cases, the memory system may generate the first asymmetric key pair by applying a second function to a randomly generated number. The second function may be an example of a key generation algorithm using elliptic curve cryptography. Additionally, or alternatively, the second function may be an example of a post-quantum resistant cryptography. In some examples, the memory system may generate the randomly generated number using a random number generator in accordance with various security protocols and standards. For example, the random number generator may be an example of a deterministic random bit generator (DRBG).

At 220, the memory system may encrypt the asymmetric key pair using the first wrapping key. For example, the memory system may implement a key wrap algorithm using the asymmetric key pair and the first wrapping key as an input to the key wrap algorithm, and the key wrap algorithm may output the encrypted asymmetric key pair. In some cases, the memory system may use the encrypted asymmetric key pair as part of an attestation procedure to securely communicate with separate entities, such as a host system.

At 225, the memory system may generate a certificate using the encrypted asymmetric key pair. In some cases, the memory system may embed or otherwise include aspects of the encrypted asymmetric key pair, such as a public key of the encrypted asymmetric key pair, in the certificate. For example, the certificate may include a non-encrypted (e.g., cleartext) version of the public key of the asymmetric key pair. The memory system may transmit the certificate to the host system, which may allow the memory system to attest (e.g., verify, certify) the identity of the memory system to the host system. In some examples, the memory system may communicate the certificate according to a security protocol, such as a Security Protocol and Data Model (SPDM).

In some cases, to comply with security protocols, the memory system may utilize a single key for a single purpose. Accordingly, to operate according to the security protocols, the memory system may generate and manage multiple asymmetric key pairs to support different aspects of communication with a host system. In some cases, the memory system may use the identifier as keying material for one or more additional keys to support communication in accordance with the security protocols. For example, at 230, the memory system may generate a second wrapping key (e.g., an alias wrapping key) using the device identifier. In some cases, the memory system may generate the second wrapping key by applying a function (e.g., a KDF) to the device identifier and a second cryptographic representation of the software image of the memory system.

At 235, the memory system may generate a second asymmetric key pair (e.g., an alias public key and an alias private key). In some cases, the memory system may generate the second asymmetric key pair by applying a function to a randomly generated number. The second function may be an example of a signature algorithm, such as a key generation algorithm using elliptic curve cryptography (e.g., an ECDSA). Additionally, or alternatively, the second function may be an example of a post-quantum resistant signing scheme. In some examples, the memory system may generate the randomly generated number using a random number generator in accordance with various security protocols and standards. For example, the random number generator may be an example of a DRBG.

At 240, the memory system may encrypt the second asymmetric key pair using the second wrapping key. For example, the memory system may implement a key wrap algorithm using the second asymmetric key pair and the first wrapping key as an input to the key wrap algorithm, and the key wrap algorithm may output the encrypted second asymmetric key pair. In some cases, the memory system may use the encrypted second asymmetric key pair as part of an attestation procedure to securely communicate with separate entities, such as the host system.

At 245, the memory system may generate a certificate using the encrypted second asymmetric key pair. In some cases, the memory system may embed or otherwise include aspects of the encrypted second asymmetric key pair, such as a public key of the encrypted asymmetric key pair, in the certificate. For example, the certificate may include a non-encrypted (e.g., cleartext) version of the public key of the asymmetric key pair. The memory system may transmit the certificate to the host system, which may allow the memory system to attest (e.g., verify, certify) the identity of the memory system to the host system. In some examples, the memory system may communicate the certificate according to a security protocol, such as a SPDM.

By incorporating the device identifier as keying material as part of generating the first wrapping key, first asymmetric key pair, second wrapping key, and second asymmetric key pair, the memory system may allow the memory system to attest the identity of the memory system to the host system (e.g., to attest that both the software component and the hardware component are legitimate). Such techniques may allow the memory system to efficiently incorporate the device identifier as part of complying with various security protocols, which may improve the security of the communication between the memory system and the host system and decrease complexity associated with generating and securely communicating certificates, and accordingly decrease computational resource consumption, among other benefits.

The described techniques may allow a memory system to utilize DICE techniques (e.g., generating one or more keys using the device identifier) while complying with government security protocols, such as the Federal Information Processing Standards (FIPS). For example, by using the device identifier as keying material at 210 and 230, the memory system may generate the first asymmetric key pair and the second asymmetric key pair in accordance with FIPS protocols. Such compliance may increase the security of communications associated with the memory system using DICE techniques, while allowing the memory system to operate in environments governed by FIPS.

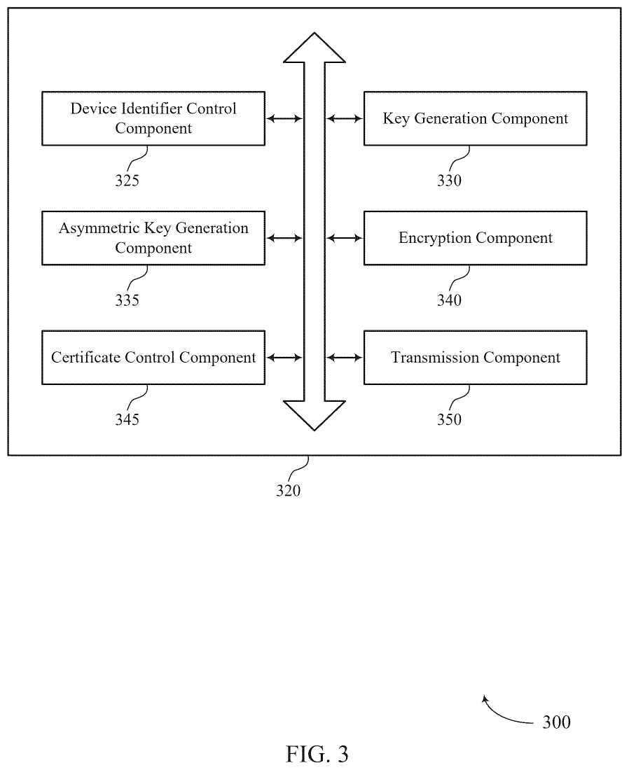

FIG. 3 shows a block diagram 300 of a memory system 320 that supports secure key generation using device identifiers in accordance with examples as disclosed herein. The memory system 320 may be an example of aspects of a memory system as described with reference to FIGS. 1 through 2. The memory system 320, or various components thereof, may be an example of means for performing various aspects of secure key generation using device identifiers as described herein. For example, the memory system 320 may include a device identifier control component 325, a key generation component 330, an asymmetric key generation component 335, an encryption component 340, a certificate control component 345, a transmission component 350, or any combination thereof. Each of these components, or components of subcomponents thereof (e.g., one or more processors, one or more memories), may communicate, directly or indirectly, with one another (e.g., via one or more buses).

The device identifier control component 325 may be configured as or otherwise support a means for generating a device identifier of the memory system based on a cryptographic representation of a software image in the memory system and a cryptographic representation of a hardware layer of the memory system. The key generation component 330 may be configured as or otherwise support a means for generating a first key using the device identifier based on applying a function to the device identifier. The asymmetric key generation component 335 may be configured as or otherwise support a means for generating an asymmetric key pair based on applying a second function to a value generated using a random number generator. The encryption component 340 may be configured as or otherwise support a means for encrypting the asymmetric key pair using the first key.

In some examples, the certificate control component 345 may be configured as or otherwise support a means for generating a certificate based on the asymmetric key pair, where the certificate is associated with attesting the memory system to a host system. In some examples, the transmission component 350 may be configured as or otherwise support a means for transmitting the certificate to the host system.

In some examples, attesting the memory system to the host system is in accordance with a Security Protocol and Data Model.

In some examples, the key generation component 330 may be configured as or otherwise support a means for generating a second key using the device identifier based on applying a third function to the device identifier and a second cryptographic representation of the software image of the memory system. In some examples, the asymmetric key generation component 335 may be configured as or otherwise support a means for generating a second asymmetric key pair based on applying a fourth function to a second value generated using the random number generator. In some examples, the encryption component 340 may be configured as or otherwise support a means for encrypting the second asymmetric key pair using the second key.

In some examples, the certificate control component 345 may be configured as or otherwise support a means for generating a certificate based on the second asymmetric key pair, where the certificate is associated with attesting the memory system to a host system. In some examples, the transmission component 350 may be configured as or otherwise support a means for transmitting the certificate to the host system.

In some examples, to support applying the second function, the asymmetric key generation component 335 may be configured as or otherwise support a means for performing a signature algorithm on the value, where encrypting the asymmetric key pair using the first key is based on performing the signature algorithm on the value.

In some examples, the cryptographic representation of the software image is based on a digest of the software image.

In some examples, the software image includes initialization instructions for a computing system including the memory system.

In some examples, the software image includes an operating system for a computing system including the memory system.

In some examples, the hardware layer of the memory system includes a physically unclonable function of the memory system.

In some examples, the described functionality of the memory system 320, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 320, or various components thereof, may be implemented at least in part by instructions (e.g., stored in memory, non-transitory computer-readable medium) executable by such at least one processor.

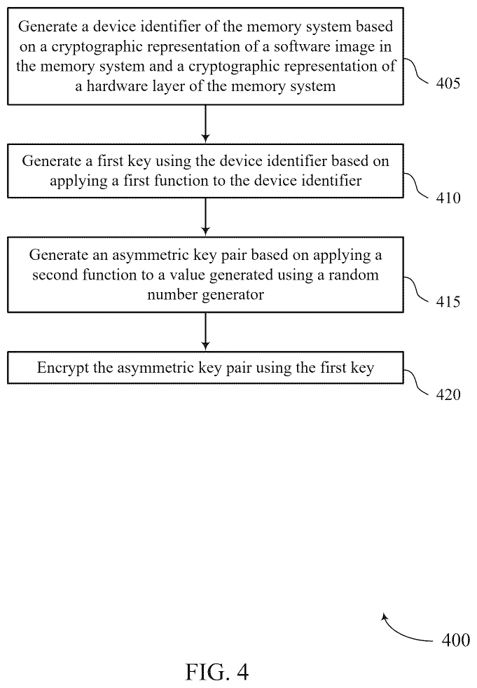

FIG. 4 shows a flowchart illustrating a method 400 that supports secure key generation using device identifiers in accordance with examples as disclosed herein. The operations of method 400 may be implemented by a memory system or its components as described herein. For example, the operations of method 400 may be performed by a memory system as described with reference to FIGS. 1 through 3. In some examples, a memory system may execute a set of instructions to control the functional elements of the device to perform the described functions. Additionally, or alternatively, the memory system may perform aspects of the described functions using special-purpose hardware.

At 405, the method may include generating a device identifier, such as the device identifier generated at 205 of the process 200, of the memory system based on a cryptographic representation of a software image in the memory system and a cryptographic representation of a hardware layer of the memory system. In some examples, aspects of the operations of 405 may be performed by a device identifier control component 325 as described with reference to FIG. 3.

At 410, the method may include generating a first key, such as the first wrapping key generated at 210 of the process 200, using the device identifier based on applying a function to the device identifier. In some examples, aspects of the operations of 410 may be performed by a key generation component 330 as described with reference to FIG. 3.

At 415, the method may include generating an asymmetric key pair, such as the first asymmetric key pair generated at 215 of the process 200, based on applying a second function to a value generated using a random number generator. In some examples, aspects of the operations of 415 may be performed by an asymmetric key generation component 335 as described with reference to FIG. 3.

At 420, the method may include encrypting the asymmetric key pair using the first key, for example in accordance with encrypting the first asymmetric key pair at 220 of the process 200. In some examples, aspects of the operations of 420 may be performed by an encryption component 340 as described with reference to FIG. 3.

In some examples, an apparatus as described herein may perform a method or methods, such as the method 400. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for generating a device identifier of the memory system based on a cryptographic representation of a software image in the memory system and a cryptographic representation of a hardware layer of the memory system; generating a first key using the device identifier based on applying a function to the device identifier; generating an asymmetric key pair based on applying a second function to a value generated using a random number generator; and encrypting the asymmetric key pair using the first key.

Aspect 2: The method, apparatus, or non-transitory computer-readable medium of aspect 1, further including operations, features, circuitry, logic, means, or instructions, or any combination thereof for generating a certificate based on the asymmetric key pair, where the certificate is associated with attesting the memory system to a host system and transmitting the certificate to the host system.

Aspect 3: The method, apparatus, or non-transitory computer-readable medium of aspect 2, where attesting the memory system to the host system is in accordance with a Security Protocol and Data Model.

Aspect 4: The method, apparatus, or non-transitory computer-readable medium of any of aspects 1 through 3, further including operations, features, circuitry, logic, means, or instructions, or any combination thereof for generating a second key using the device identifier based on applying a third function to the device identifier and a second cryptographic representation of the software image of the memory system; generating a second asymmetric key pair based on applying a fourth function to a second value generated using the random number generator; and encrypting the second asymmetric key pair using the second key.

Aspect 5: The method, apparatus, or non-transitory computer-readable medium of aspect 4, further including operations, features, circuitry, logic, means, or instructions, or any combination thereof for generating a certificate based on the second asymmetric key pair, where the certificate is associated with attesting the memory system to a host system and transmitting the certificate to the host system.

Aspect 6: The method, apparatus, or non-transitory computer-readable medium of any of aspects 1 through 5, where applying the second function includes operations, features, circuitry, logic, means, or instructions, or any combination thereof for performing a signature algorithm on the value, where encrypting the asymmetric key pair using the first key is based on performing the signature algorithm on the value.

Aspect 7: The method, apparatus, or non-transitory computer-readable medium of any of aspects 1 through 6, where the cryptographic representation of the software image is based on a digest of the software image.

Aspect 8: The method, apparatus, or non-transitory computer-readable medium of any of aspects 1 through 7, where the software image includes initialization instructions for a computing system including the memory system.

Aspect 9: The method, apparatus, or non-transitory computer-readable medium of any of aspects 1 through 8, where the software image includes an operating system for a computing system including the memory system.

Aspect 10: The method, apparatus, or non-transitory computer-readable medium of any of aspects 1 through 9, where the hardware layer of the memory system includes a physically unclonable function of the memory system.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method by a memory system, comprising:
generating a device identifier of the memory system based on a cryptographic representation of a software image in the memory system and a cryptographic representation of a hardware layer of the memory system;
generating a first key using the device identifier based on applying a first function to the device identifier;
generating an asymmetric key pair based on applying a second function to a value generated using a random number generator; and
encrypting the asymmetric key pair using the first key.

2. The method of claim 1, further comprising:
generating a certificate based on the asymmetric key pair, wherein the certificate is associated with attesting the memory system to a host system; and
transmitting the certificate to the host system.

3. The method of claim 2, wherein attesting the memory system to the host system is in accordance with a Security Protocol and Data Model (SPDM).

4. The method of claim 1, further comprising:
generating a second key using the device identifier based on applying a third function to the device identifier and a second cryptographic representation of the software image of the memory system;
generating a second asymmetric key pair based on applying a fourth function to a second value generated using the random number generator; and
encrypting the second asymmetric key pair using the second key.

5. The method of claim 4, further comprising:
generating a certificate based on the second asymmetric key pair, wherein the certificate is associated with attesting the memory system to a host system; and
transmitting the certificate to the host system.

6. The method of claim 1, wherein applying the second function comprises:
performing a signature algorithm on the value, wherein encrypting the asymmetric key pair using the first key is based on performing the signature algorithm on the value.

7. The method of claim 1, wherein the cryptographic representation of the software image is based on a digest of the software image.

8. The method of claim 1, wherein the software image comprises initialization instructions for a computing system comprising the memory system.

9. The method of claim 1, wherein the software image comprises an operating system for a computing system comprising the memory system.

10. The method of claim 1, wherein the hardware layer of the memory system comprises a physically unclonable function of the memory system.

11. A non-transitory computer-readable medium storing code, the code comprising instructions executable by one or more processors to:
generate a device identifier of a memory system based on a cryptographic representation of a software image in the memory system and a cryptographic representation of a hardware layer of the memory system;
generate a first key using the device identifier based on applying a first function to the device identifier;
generate an asymmetric key pair based on applying a second function to a value generated using a random number generator; and
encrypt the asymmetric key pair using the first key.

12. The non-transitory computer-readable medium of claim 11, wherein the instructions are further executable by the one or more processors to:
generate a certificate based on the asymmetric key pair, wherein the certificate is associated with attesting the memory system to a host system; and
transmit the certificate to the host system.

13. The non-transitory computer-readable medium of claim 12, wherein attesting the memory system to the host system is in accordance with a Security Protocol and Data Model (SPDM).

14. The non-transitory computer-readable medium of claim 11, wherein the instructions are further executable by the one or more processors to:
generate a second key using the device identifier based on applying a third function to the device identifier and a second cryptographic representation of the software image of the memory system;
generate a second asymmetric key pair based on applying a fourth function to a second value generated using the random number generator; and
encrypt the second asymmetric key pair using the second key.

15. The non-transitory computer-readable medium of claim 14, wherein the instructions are further executable by the one or more processors to:
generate a certificate based on the second asymmetric key pair, wherein the certificate is associated with attesting the memory system to a host system; and
transmit the certificate to the host system.

16. The non-transitory computer-readable medium of claim 11, wherein the instructions to apply the second function are executable by the one or more processors to:
perform a signature algorithm on the value, wherein encrypting the asymmetric key pair using the first key is based on performing the signature algorithm on the value.

17. The non-transitory computer-readable medium of claim 11, wherein the cryptographic representation of the software image is based on a digest of the software image.

18. The non-transitory computer-readable medium of claim 11, wherein the software image comprises initialization instructions for a computing system comprising the memory system.

19. The non-transitory computer-readable medium of claim 11, wherein the software image comprises an operating system for a computing system comprising the memory system.

20. The non-transitory computer-readable medium of claim 11, wherein the hardware layer of the memory system comprises a physically unclonable function of the memory system.

21. A memory system, comprising:
one or more memory devices; and
processing circuitry coupled with the one or more memory devices and configured to cause the memory system to:
generate a device identifier of the memory system based on a cryptographic representation of a software image in the memory system and a cryptographic representation of a hardware layer of the memory system;
generate a first key using the device identifier based on applying a first function to the device identifier;
generate an asymmetric key pair based on applying a second function to a value generated using a random number generator; and
encrypt the asymmetric key pair using the first key.

22. The memory system of claim 21, wherein the processing circuitry is further configured to cause the memory system to:
generate a certificate based on the asymmetric key pair, wherein the certificate is associated with attesting the memory system to a host system; and
transmit the certificate to the host system.

23. The memory system of claim 22, wherein attesting the memory system to the host system is in accordance with a Security Protocol and Data Model (SPDM).

24. The memory system of claim 21, wherein the processing circuitry is further configured to cause the memory system to:
generate a second key using the device identifier based on applying a third function to the device identifier and a second cryptographic representation of the software image of the memory system;
generate a second asymmetric key pair based on applying a fourth function to a second value generated using the random number generator; and
encrypt the second asymmetric key pair using the second key.

25. The memory system of claim 24, wherein the processing circuitry is further configured to cause the memory system to:
generate a certificate based on the second asymmetric key pair, wherein the certificate is associated with attesting the memory system to a host system; and
transmit the certificate to the host system.
